(19) United States
(12) Patent Application Publication
(10) Pub. No.: US 2019/0332458 A1
(43) Pub. Date: Oct. 31, 2019

(54) INFORMATION PROCESSING SYSTEM, INPUT VALUE VERIFICATION SUPPORT PROGRAM, AND INPUT VALUE VERIFICATION PROGRAM

(71) Applicant: FUJITSU LIMITED, Kawasaki-shi (JP)

(72) Inventor: Hiroki Kimura, Numadu (JP)

(73) Assignee: FUJITSU LIMITED, Kawasaki-shi (JP)

(21) Appl. No.: 16/287,434

(22) Filed: Feb. 27, 2019

(30) Foreign Application Priority Data
Apr. 25, 2018 (JP) 2018-084005

(51) Int. Cl. G06F 11/07; G06F 9/50; G06F 3/06; G06F 11/34

(52) U.S. Cl. CPC G06F 11/0745; G06F 9/5027; G06F 11/34; G06F 3/0631; G06F 3/067; G06F 3/0604

(57) ABSTRACT

An information processing system includes a server and a terminal device. The server stores definition information defining a permissible range of an input value in a memory; outputs the definition information according to an obtainment request; and executes a process using the input value included in a process request according to the process request including the input value. The terminal device receives the definition information from the server; displays a screen including an input area of the input value on the display device; determines whether or not the input value is within the permissible range based on the definition information received from the server, when the input value is input to the input area; and transmits the process request including the input value to the server in a case where it is determined that the input value is within the permissible range.

### CROSS-REFERENCE TO RELATED APPLICATION

This application is based upon and claims the benefit of priority of the prior Japanese Patent Application No. 2018-84005, filed on Apr. 25, 2018, the entire contents of which are incorporated herein by reference.

### FIELD

The embodiments discussed herein are related to an information processing system, an input value verification support program, and an input value verification program.

### BACKGROUND

An information processing system performs a process of cooperating a terminal device used by a user and a server. For example, the terminal device controls a screen by using a web browser and the server manages or operates data based on input contents to the screen on which the web browser is displayed.

In a case of implementing the cooperative process between the terminal device and the server to the information processing system, a software component (hereinafter, referred to as “component”) for each of the terminal device and the server is created. It is possible to create the component for the cooperative process between the terminal device and the server by using a representational state transfer (REST)-application programming interface (API), for example.

An example of the cooperative process between the terminal device and the server is a cooperative process in which an input value (for example, a character string) input by a user is transmitted from the terminal device to the server and the server executes a process according to the input value. In the cooperative process, in a case where the input value processible by the server is limited, the server performs an input value check (validation). In the input value check, the server checks whether the input value is within a range of a value permitted to be input.

As a technology related to the cooperative process between the terminal device and the server, for example, there is a system for managing a server configuration in a traffic director or another type of a server environment. As an REST-API method for an existing system, a conversion processing technology capable of generally corresponding to various protocols also may be considered.

Japanese Laid-open Patent Publication No. 2017-062840 and Japanese Laid-open Patent Publication No. 2017-054411 are examples of the related art.

The terminal device also may perform the input value check. For example, when the input value check is appropriately performed on both the terminal device and the server, a highly reliable input value check is performed. In a case where the terminal device also performs the input value check, other than the component for checking the input value on a server side, a component for checking the input value on a terminal device side is created. For this reason, in some cases, contents of the input value check performed on the terminal device side are not unified with contents of the input value check in the server. When the check contents are not unified, there is a possibility that although the user performs an input valid to a specification on the server side, it is erroneously determined that an input value is inappropriate in the terminal device, for example. Therefore, in the case where the contents of the input value check are not unified, quality of the service provided by using the system is deteriorated.

As one aspect, an object of the present embodiment is to improve reliability of the input value check.

### SUMMARY

According to an aspect of the embodiments, an information processing system includes a server and a terminal device. The server stores definition information defining a permissible range of an input value in a memory; outputs the definition information according to an obtainment request; and executes a process using the input value included in a process request according to the process request including the input value. The terminal device receives the definition information from the server; displays a screen including an input area of the input value on the display device; determines whether or not the input value is within the permissible range based on the definition information received from the server, when the input value is input to the input area; and transmits the process request including the input value to the server in a case where it is determined that the input value is within the permissible range.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram illustrating an example of an input value check method according to a first embodiment;

FIG. 2 is a diagram illustrating a system configuration example according to a second embodiment;

FIG. 3 is a diagram illustrating a hardware configuration example of a storage operation management server;

FIG. 4 is a block diagram illustrating a function of each of devices;

FIG. 5 is a diagram illustrating an example of a static definition file;

FIG. 6 is a diagram illustrating an example of a dynamic definition DB;

FIG. 7 is a diagram illustrating a display example of an account creation screen;

FIG. 8 is a diagram illustrating an example of a login screen;

FIG. 9 is a diagram illustrating an example of a storage management screen;

FIG. 10 is a diagram illustrating an example of a pool creation screen;

FIG. 11 is a diagram illustrating an example of an input value check process;

FIG. 12 is a diagram illustrating an example of generating definition information in the storage operation management server;

FIG. 13 is a diagram illustrating an example of an input value check in a terminal device;

FIG. 14 is a diagram illustrating another example of the input value check in the terminal device;

FIG. 15 is a diagram illustrating an example of an input value check in the storage operation management server;

FIG. 16 is a sequence diagram illustrating an example of a procedure of a process of obtaining definition information according to screen display;

FIG. 17 is a flowchart illustrating an example of a procedure of a process of providing definition information in the storage operation management server;

FIG. 18 is a sequence diagram illustrating an example of a procedure of an input value check process in the terminal device;

FIG. 19 is a flowchart illustrating an example of a procedure of the input value check process for each character;

FIG. 20 is a sequence diagram illustrating an example of an operation procedure of a storage device; and

FIG. 21 is a flowchart illustrating an example of a procedure of a process of updating a dynamic definition DB.

### DESCRIPTION OF EMBODIMENTS

Hereinafter, the present embodiments will be described with reference to drawings. Each of the embodiment may be implemented by combining a plurality of embodiments within a range without contradiction.

### First Embodiment

First, the first embodiment will be described. The first embodiment provides an information processing system in which both of a server and a terminal device perform input value checks.

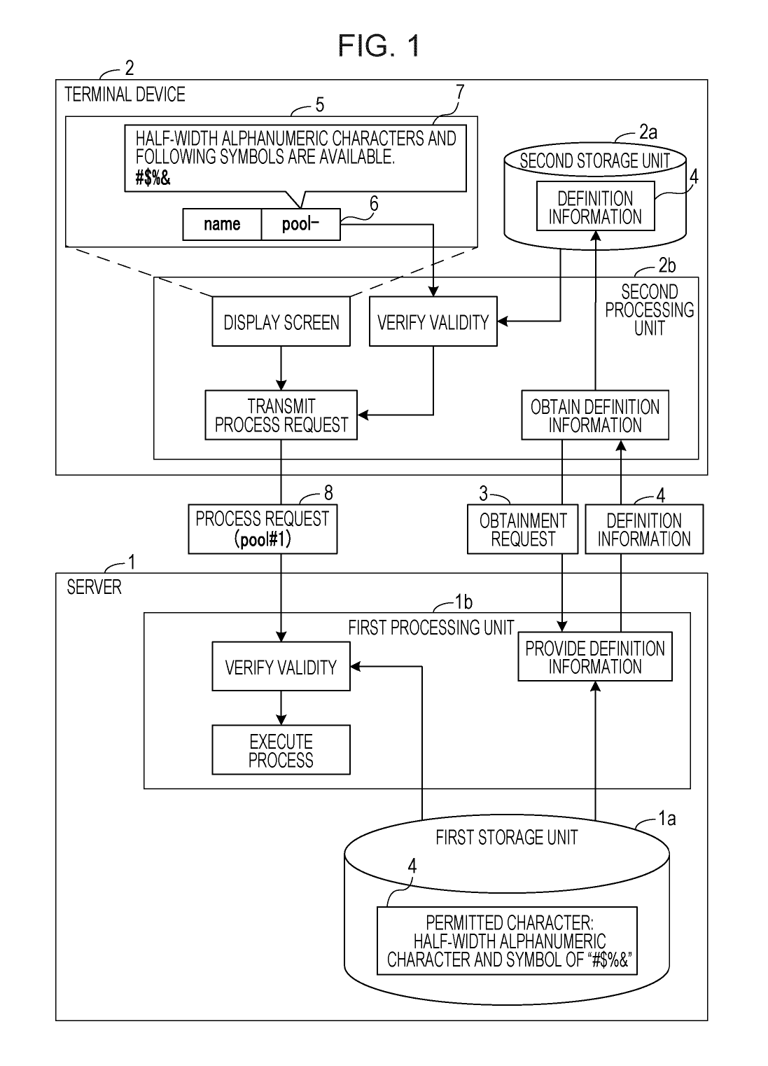

FIG. 1 is a diagram illustrating an example of an input value check method according to the first embodiment. The information processing system includes a server 1 and a terminal device 2.

The server 1 includes a first storage unit 1a and a first processing unit 1b. By using the first storage unit 1a and the first processing unit 1b, the server 1 executes an input value check of the server 1 and supports an input value check by the terminal device 2. For example, the server 1 causes the first processing unit 1b to execute an input value verification support program in which an input value check support process is described, so that an input value verification support method for the terminal device 2 is realized. The first storage unit 1a is, for example, a memory or a storage device included in the server 1. The first processing unit 1b is, for example, a processor or an arithmetic circuit included in the server 1.

The terminal device 2 includes a second storage unit 2a and a second processing unit 2b. The terminal device 2 executes an input value check by using the second storage unit 2a and the second processing unit 2b. For example, the terminal device 2 causes the second processing unit 2b to execute an input value verification program in which an input value check process is described, so that an input value verification method is realized. The second storage unit 2a is, for example, a memory or a storage device included in the terminal device 2. The second processing unit 2b is, for example, a processor or an arithmetic circuit included in the terminal device 2.

The input value check is performed by a cooperative process between the server 1 and the terminal device 2. Specifically, the cooperative process is as follows.

The first storage unit 1a of the server 1 stores definition information 4, in which a permissible range of an input value is defined, in advance. In the definition information 4, for example, a permitted character permitted to be included in a process request 8 is defined. When performing the cooperative process with the server 1, the second processing unit 2b of the terminal device 2 obtains the definition information 4 from the server 1. For example, the second processing unit 2b of the terminal device 2 transmits an obtainment request 3 of the definition information 4 to the server 1. In response to the obtainment request 3, the first processing unit 1b of the server 1 responsively transmits the definition information 4. For example, the first processing unit 1b reads the definition information 4 from the first storage unit 1a and transmits the read definition information 4 to the terminal device 2. The second processing unit 2b of the terminal device 2 receives the definition information 4 transmitted from the server 1. The second processing unit 2b of the terminal device 2 stores the received definition information 4 in the second storage unit 2a.

After then, the second processing unit 2b of the terminal device 2 displays a screen 5 including an input area 6 of the input value on a display device. When a user inputs an input value such as a character string or the like to the input area 6, the second processing unit 2b determines whether or not the input value is within the permissible range based on the definition information 4 received from the server 1. For example, each time one character is input to the input area 6, the second processing unit 2b determines whether or not the input one character corresponds to the permitted character permitted to be included in the process request 8. In a case where the input one character does not correspond to the permitted character, the second processing unit 2b displays a message 7 for explaining, for example, that the input is inappropriate on the screen 5.

For example, in the example in FIG. 1, the definition information 4 indicates that a half-width alphanumeric character and a symbol of “#$%&” are permitted characters. At this time, when a symbol of “-” is input to the input area 6, the second processing unit 2b determines that the input character does not correspond to the permitted character. The second processing unit 2b displays the message 7 for explaining a type of a character permitted to be input. Accordingly, the user may recognize that an input of the symbol of “-” is erroneous. After then, the user deletes the symbol of “-” and inputs another character, for example.

In a case where it is determined that the input value is within the permissible range, the second processing unit 2b transmits the process request 8 including the input value to the server 1. According to the process request 8 including the input value, the first processing unit 1b of the server 1 executes a process of using the input value included in the process request 8.

Before the process according to the process request 8 is executed, the first processing unit 1b may perform the input value check (validity verification). For example, when receiving the process request 8, the first processing unit 1b determines whether or not the input value included in the process request 8 is within the permissible range based on the definition information 4. In a case where it is determined that the input value is within the permissible range, the first processing unit 1b executes the process by using the character string.

In this manner, in the terminal device 2, it is possible to perform the input value check by using the definition information 4 common to the server 1. As a result, a discrepancy in contents of the input value check between the terminal device 2 and the server 1 is suppressed and reliability of the input value check is improved.

In some cases, contents of the definition information 4 managed by the server 1 may be changed by a system administrator or the like. Since the terminal device 2 obtains the definition information 4 from the server 1, even in a case where the contents of the definition information 4 are changed, a software executed on a side of the terminal device 2 may not be changed. For this reason, it is easy to develop the software for checking the input value in the terminal device 2.

In the example in FIG. 1, only one piece of definition information 4 is stored in the first storage unit 1a, but the server 1 may cause the first storage unit 1a to store a plurality of pieces of definition information. In this case, the first processing unit 1b of the server 1 selects appropriate definition information according to the obtainment request 3 from the terminal device 2 and provides the selected definition information to the terminal device 2.

For example, in a case where the server 1 manages a plurality of storage devices, the first storage unit 1a stores definition information for each device respectively corresponding to the plurality of storage devices. In this case, the second processing unit 2b of the terminal device 2 transmits the obtainment request 3 specifying the storage device to be operated to the server 1 according to a selection input of the storage device to be operated. The first processing unit 1b of the server 1 transmits definition information for each device corresponding to the storage device to be operated according to the obtainment request 3 specifying the storage device to be operated to the terminal device 2. The terminal device 2 receives the definition information for each device, corresponding to the storage device to be operated, transmitted from the server 1.

By using the definition information for each device prepared for each of the storage devices in this manner, the terminal device 2 and the server 1 may perform the input value check by the definition information corresponding to the storage device to be operated. Accordingly, for example, even in a case where settable characters by setting operations are different from one another for each of the storage devices, it is possible to perform an appropriate input value check according to the storage device to be operated.

When the first storage unit 1a of the server 1 stores the definition information for each device corresponding to each of the plurality of storage devices, the first processing unit 1b may automatically update the definition information for each device according to a change in a state of the storage device. For example, the first processing unit 1b monitors states of the plurality of storage devices, and in a case of detecting one storage device having a changed state, the first processing unit 1b obtains definition information for each device, in which an available character by an operation to the one storage device is defined, from the one storage device. An example of the change in the state includes an update of a configuration setting file in the storage device. The first processing unit 1b stores the obtained definition information for each device in association with the one storage device in the first storage unit 1a.

In this manner, by automatically updating the definition information, it is possible to maintain the latest state of the definition information 4. As a result, reliability of the input value check is improved.

### Second Embodiment

Next, the second embodiment will be described. The second embodiment provides a system in which a server and a terminal device cooperatively manages a use of a storage device and improves reliability of an input value check.

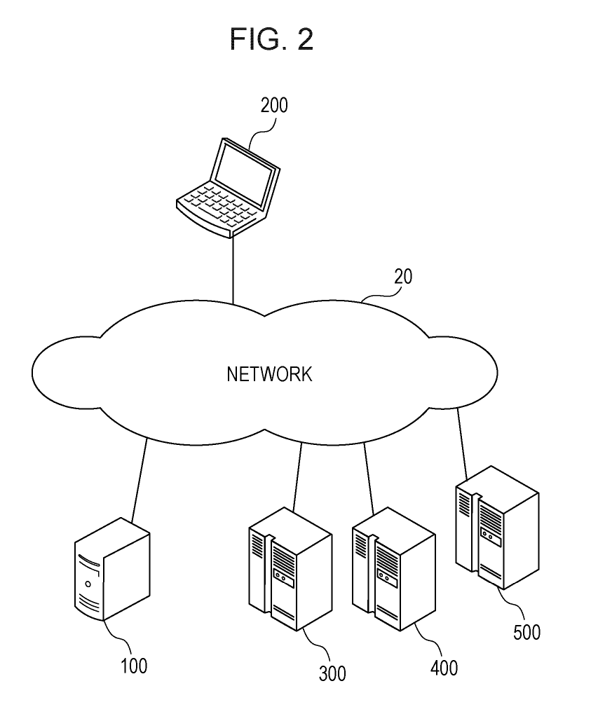

FIG. 2 is a diagram illustrating a system configuration example according to the second embodiment. A storage operation management server 100, a terminal device 200, and a plurality of storage devices 300, 400, and 500 are connected via a network 20. The storage operation management server 100 manages the storage devices 300, 400, and 500 in response to a request from the terminal device 200. For example, in response to the request from the terminal device 200, the storage operation management server 100 creates a storage pool using the storage devices 300, 400, and 500. The storage pool is that a collection of one or more physical storage devices may be handled virtually as one disk.

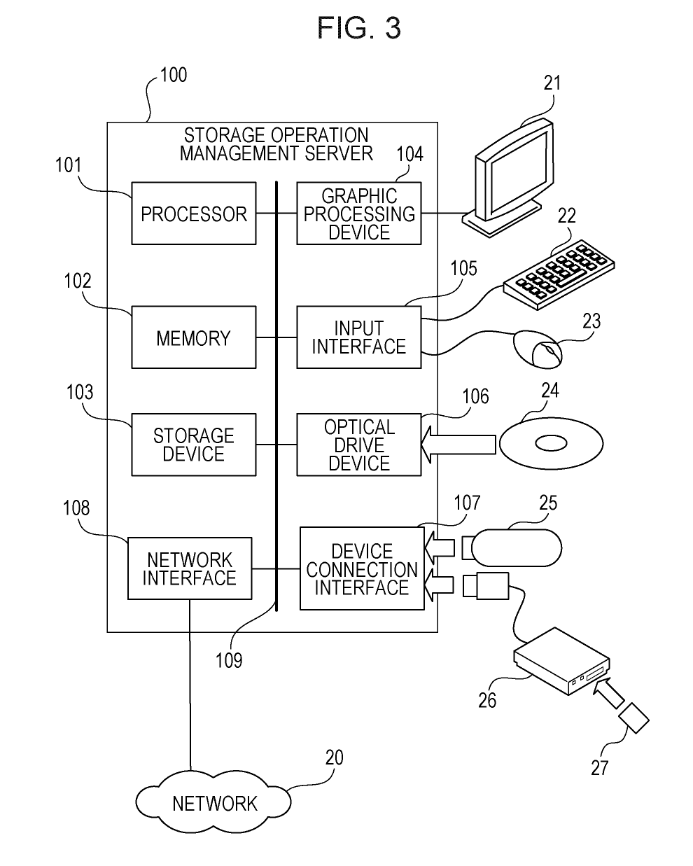

FIG. 3 is a diagram illustrating a hardware configuration example of a storage operation management server. In the storage operation management server 100, a processor 101 controls all of devices. A memory 102 and a plurality of peripheral devices are connected to the processor 101 via a bus 109. The processor 101 may be a multiprocessor. The processor 101 is, for example, a central processing unit (CPU), a micro processing unit (MPU), or a digital signal processor (DSP). At least a part of a function realized by the processor 101 executing a program may be realized by an electronic circuit such as an application specific integrated circuit (ASIC), a programmable logic device (PLD), or the like.

The memory 102 is used as a main storage device of the storage operation management server 100. The memory 102 temporarily stores at least a part of an operating system (OS) program or an application program to be executed by the processor 101. In addition, the memory 102 stores various types of data used for a process by the processor 101. As the memory 102, for example, a volatile semiconductor memory device such as a random access memory (RAM) or the like is used.

The peripheral device connected to the bus 109 includes a storage device 103, a graphic processing device 104, an input interface 105, an optical drive device 106, a device connection interface 107, and a network interface 108.

The storage device 103 writes and reads data electrically or magnetically to a built-in recording medium. The storage device 103 is used as an auxiliary storage device of a computer. The storage device 103 stores an OS program, an application program, and various types of data. As the storage device 103, for example, a hard disk drive (HDD) or a solid state drive (SSD) may be used.

A monitor 21 is connected to the graphic processing device 104. The graphic processing device 104 displays an image on a screen of the monitor 21 according to a command from the processor 101. An example of the monitor 21 includes a display device, a liquid crystal display device, or the like using organic electro luminescence (EL).

A keyboard 22 and a mouse 23 are connected to the input interface 105. The input interface 105 transmits a signal transmitted from the keyboard 22 or the mouse 23 to the processor 101. The mouse 23 is an example of a pointing device, and another pointing device also may be used. An example of the other pointing device includes a touch panel, a tablet, a touch pad, a track ball, or the like.

The optical drive device 106 reads data recorded on an optical disk 24 by using a laser beam or the like. The optical disk 24 is a portable recording medium on which data is recorded so as to be readable by reflection of light. An example of the optical disk 24 includes a digital versatile disc (DVD), a DVD-RAM, a compact disc read only memory (CD-ROM), a CD-recordable (R)/rewritable (RW), or the like.

The device connection interface 107 is a communication interface for connecting a peripheral device to the storage operation management server 100. For example, a memory device 25 or a memory reader and writer 26 may be connected to the device connection interface 107. The memory device 25 is a recording medium having a communication function with the device connection interface 107. The memory reader and writer 26 is a device which writes data to a memory card 27 or reads the data from the memory card 27. The memory card 27 is a card type recording medium.

The network interface 108 is connected to the network 20. The network interface 108 transmits and receives data to and from another computer or a communication device via the network 20.

With the above hardware configuration, the storage operation management server 100 may realize the processing function of the second embodiment. With the same hardware configuration as the storage operation management server 100 illustrated in FIG. 3, the terminal device 200 also may realize the processing function of the second embodiment. With the same hardware as the storage operation management server 100 illustrated in FIG. 3, the server 1 and the terminal device 2 described in the first embodiment also may be realized.

The storage operation management server 100 realizes the processing function of the second embodiment by executing, for example, a program recorded on a computer readable recording medium. The program in which processing contents to be executed by the storage operation management server 100 is described may be recorded in various recording media. For example, the program to be executed by the storage operation management server 100 may be stored in the storage device 103. The processor 101 loads at least a part of the program in the storage device 103 into the memory 102 and executes the program. The program to be executed by the storage operation management server 100 also may be recorded on a portable recording medium such as the optical disk 24, the memory device 25, the memory card 27, or the like. The program stored in the portable recording medium may be executed after being installed in the storage device 103 by control from, for example, the processor 101. The processor 101 also may read and execute the program directly from the portable recording medium.

Next, a function included in each of the storage operation management server 100, the terminal device 200, and the storage devices 300, 400, and 500 will be described.

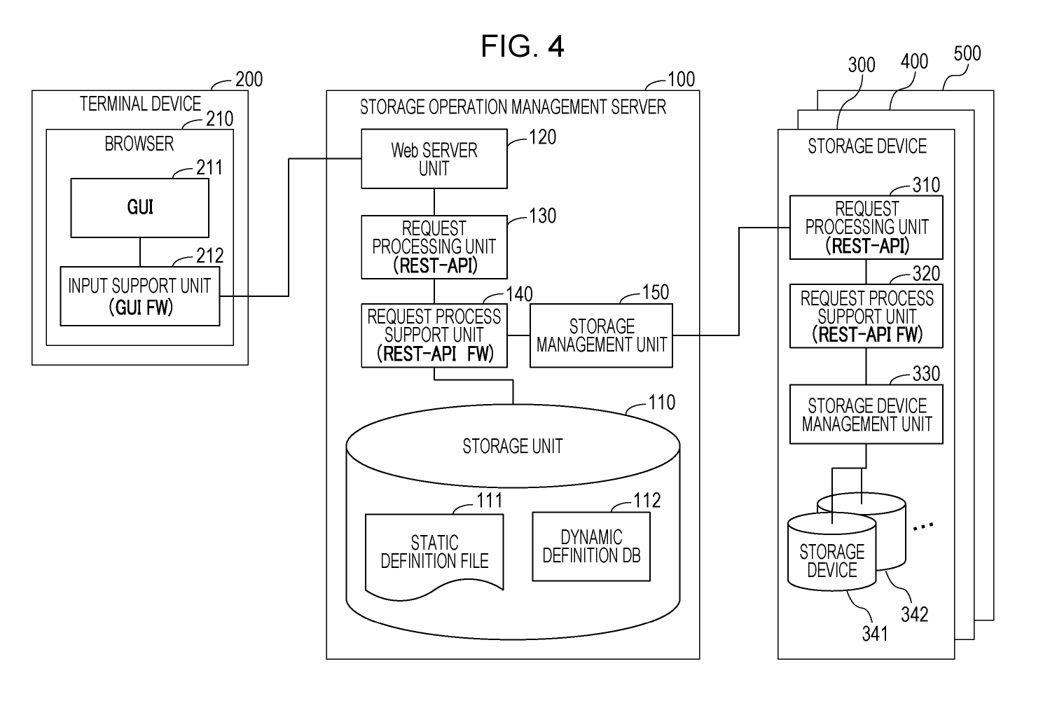

FIG. 4 is a block diagram illustrating a function of each of devices. The terminal device 200 includes a browser 210. The browser 210 interprets document data described in a hypertext markup language (HTML) or the like and displays information indicated in the document data on the monitor of the terminal device 200. The browser 210 may add a function by using a technology such as a plug-in. For example, the browser 210 has functions of a graphical user interface (GUI) 211 and an input support unit 212 so as to execute a process in cooperation with the storage operation management server 100.

The GUI 211 is an interface for the user to perform an input to the storage operation management server 100. For example, the GUI 211 causes the browser 210 to display an input screen of an operation to the storage operation management server 100.

The input support unit 212 supports the input from the user to the GUI 211. For example, each time the user inputs a character, the input support unit 212 performs a check (input value check) as to whether or not the input character is a character permitted by the storage operation management server 100. The input support unit 212 transmits data such as the character string or the like input via the GUI 211 to the storage operation management server 100. The input support unit 212 is realized by, for example, a component prepared as a framework (FW) for the GUI 211.

The storage operation management server 100 includes a storage unit 110, a web server unit 120, a request processing unit 130, a request process support unit 140, and a storage management unit 150.

The storage unit 110 stores a static definition file 111 and a dynamic definition data base (DB) 112. The static definition file 111 is a data file indicating a correspondence relationship between an input item by a user and a record indicating a definition for checking an input value for the item. The dynamic definition DB 112 is a database in which information specifically indicating contents of the input value check for operating the storage devices 300, 400, and 500 is stored in record units.

The web server unit 120 provides various contents such as an HTML format document to the browser 210 of the terminal device 200. For example, the web server unit 120 transmits a component (a file including a program) for realizing the GUI 211 and the input support unit 212, to the browser 210. When receiving a process request from the terminal device 200, the web server unit 120 transmits the process request to the request processing unit 130. The process request from the terminal device 200 includes a definition information obtainment request for requesting obtainment of definition information and an operation request for requesting a data operation according to the input character string.

According to the process request received from the web server unit 120, the request processing unit 130 executes a process related to an operation of the storage devices 300, 400, and 500. Among the processes to be executed, the request processing unit 130 requests the request process support unit 140 to process a general-purpose process provided by the request process support unit 140. The request processing unit 130 is realized by an REST-API, for example.

According to the request from the request processing unit 130, the request process support unit 140 performs a general-purpose process related to an operation of the storage devices 300, 400, and 500. For example, the request process support unit 140 generates definition information obtained by combining a static definition and a dynamic definition, based on the static definition file 111 and the dynamic definition DB 112, according to the definition information obtainment request. The request process support unit 140 performs the input value check on each of characters included in a character string, based on the static definition file 111 and the dynamic definition DB 112, according to an operation request of which an operation content is specified by the character string. When the check of all of the character is completed by the input value check, the request process support unit 140 instructs the storage management unit 150 to operate the storage devices 300, 400, and 500 according to the operation request. The request process support unit 140 is realized by an REST-API framework, for example.

According to the instruction from the request process support unit 140, the storage management unit 150 operates the storage devices 300, 400, and 500. For example, by transmitting a process request according to an REST to the storage devices 300, 400, and 500, the storage management unit 150 operates the storage devices 300, 400, and 500.

A request processing unit 310, a request process support unit 320, a storage device management unit 330, and a plurality of storage devices 341, 342, . . . are included in the storage device 300.

The request processing unit 310 operates the storage devices 341, 342, . . . according to the process request received from the storage operation management server 100. Among the processes to be executed, the request processing unit 310 requests the request process support unit 320 to process a general-purpose process provided by the request process support unit 320. The request processing unit 310 is realized by an REST-API, for example.

The request process support unit 320 performs a general-purpose process related to an operation of the storage devices 341, 342, . . . according to the request from the request processing unit 310. The request process support unit 320 is realized by an REST-API framework, for example.

The storage device management unit 330 manages the storage devices 341, 342, . . . . For example, the storage device management unit 330 performs creation of the storage pool using the storage devices 341, 342, . . . , an input and an output of data to and from the storage devices 341, 342, . . . , and the like.

The storage devices 341, 342, . . . are HDDs or SSDs.

The storage devices 400 and 500 also include the same processing function and the same storage device as the storage device 300.

A line connecting elements illustrated in FIG. 4 indicates a part of a communication path, and a communication path other than the illustrated communication path also may be set. For example, a function of each of the elements illustrated in FIG. 4 may be realized so that a program module corresponding to the element is executed in a computer.

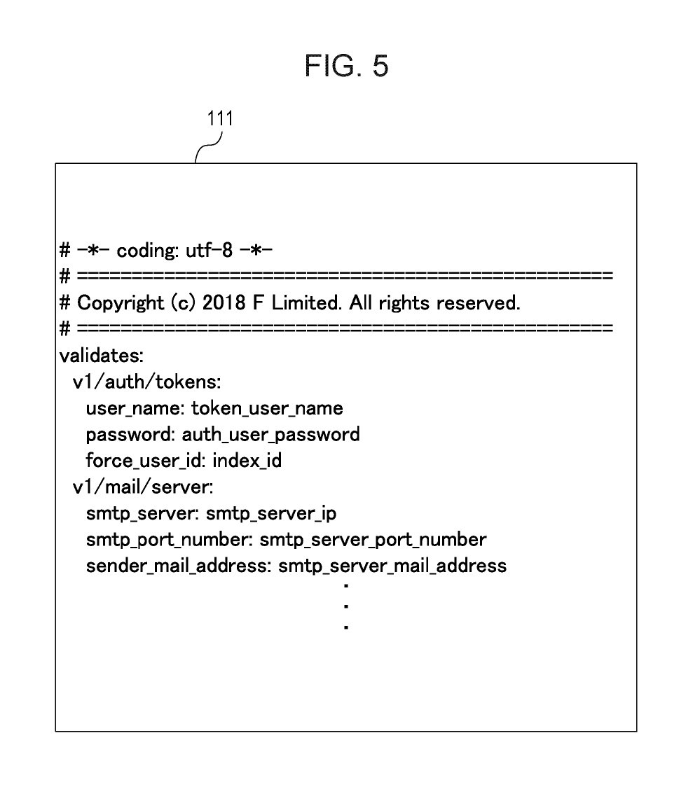

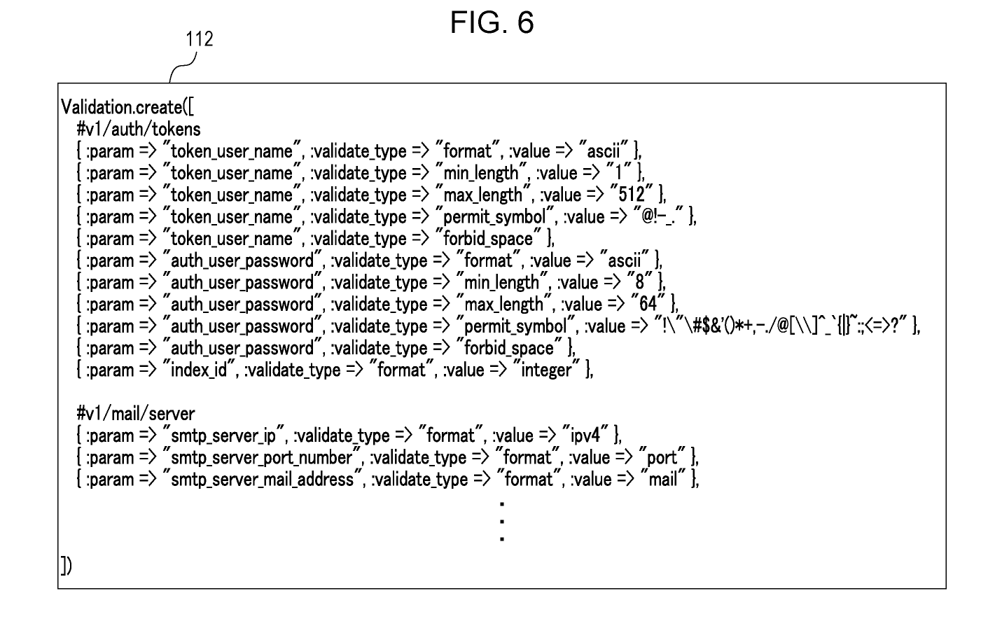

Next, the static definition file 111 and the dynamic definition DB 112 will be described in detail with reference to FIGS. 5 and 6.

FIG. 5 is a diagram illustrating an example of a static definition file. In the static definition file 111, one or more sets of a parameter name and a parameter value are set in association with an API identifier. In the example in FIG. 5, API identifiers of “v1/auth/tokens” and “v1/mail/server” are set in the static definition file 111. For example, a set of a parameter name of “user_name” and a parameter value of “token_user_name” is set in the API identifier of “v1/auth/tokens”.

FIG. 6 is a diagram illustrating an example of a dynamic definition DB. In the dynamic definition DB 112, a record indicating definition information related to a parameter value of a static definition is set in association with an API identifier. For example, “validate_type=>“format”, :value=>“ascii”” is defined in the record related to the definition information of the parameter value of “token_user_name” of the API identifier of “v1/auth/tokens”. This defines that a code system of the input character is “ASCII”. A plurality of records related to the definition information also may be registered for one parameter value.

By using the static definition file 111 and the dynamic definition DB 112, the storage operation management server 100 and the terminal device 200 perform the unified input value check.

The terminal device 200 obtains the latest definition information of the input value check from the storage operation management server 100 as appropriate. For example, when displaying a screen including an input field based on the GUI 211, the terminal device 200 obtains definition information for checking an input value related to the input value to the input field provided on the screen. Based on the obtained definition information, the input support unit 212 performs the input value check. For example, in a case where an account creation screen is displayed, the input support unit 212 checks whether or not a character input to a user name is a character available to the user name.

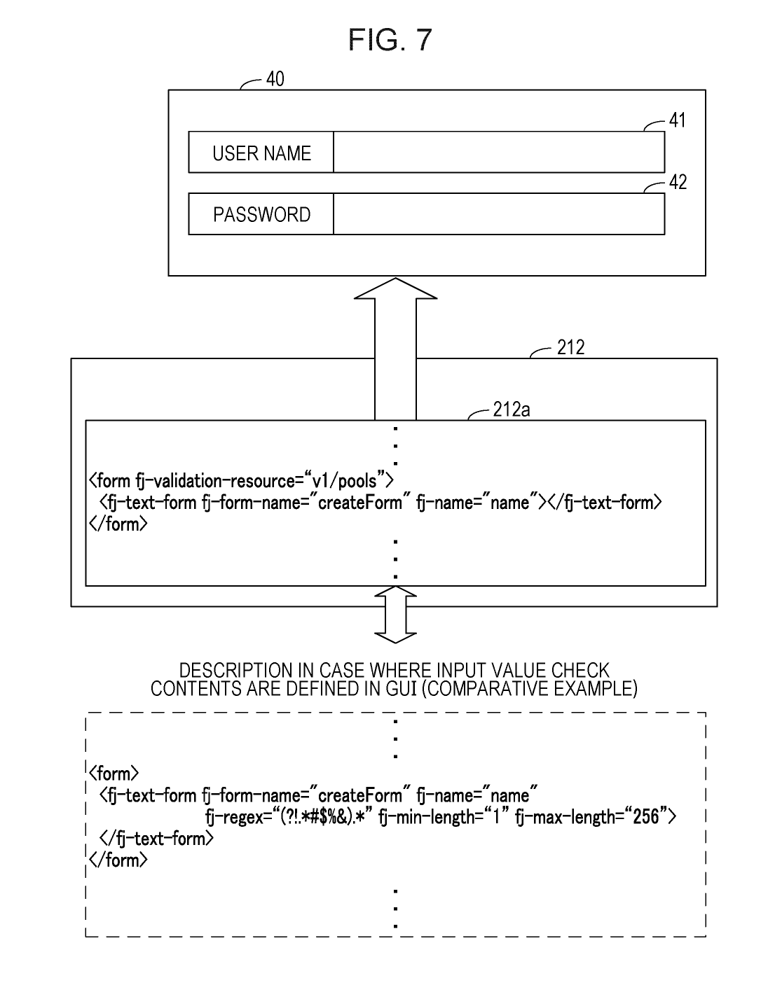

FIG. 7 is a diagram illustrating a display example of an account creation screen. In an account creation screen 40, input fields 41 and 42 of a user name and a password are provided. Contents of the account creation screen 40 are described in the input support unit 212. For example, the contents of the account creation screen 40 are defined in an input support unit description 212a. For example, the input support unit description 212a indicates that the API identifier of a parameter name of the input field 41 is “v1/pools”. In addition, the input support unit description 212a indicates that the parameter name of the input value to the input field 41 is “name”.

In this manner, in a program module of the input support unit 212, if only the API identifier of the parameter and the parameter name are specified, the input value check becomes possible. FIG. 7 illustrates a description example in a case where input value check contents are defined in the GUI 211 as a comparative example. In a case where the input value check contents are defined in the GUI 211, the contents of the input value check (which character is permitted to be input) are described in the input support unit 212. In this way, when the contents of the input value check are described in the input support unit 212, there is a possibility that discrepancy with the input value check contents in the storage operation management server 100 may occur. On the other hand, in the second embodiment, as in the input support unit description 212a, the input support unit 212 may specify only the API identifier of the parameter and the parameter name. For this reason, it is possible to suppress discrepancy of the input value check contents and it becomes easy to develop the program module of the input support unit 212.

When displaying the account creation screen 40, the input support unit 212 of the terminal device 200 obtains definition information for checking the input value related to the input value to each of the input fields 41 and 42 from the storage operation management server 100, based on the input support unit description 212a. Based on the obtained definition information, the input support unit 212 performs the input value check.

When an account is created, a login screen is displayed on the terminal device 200.

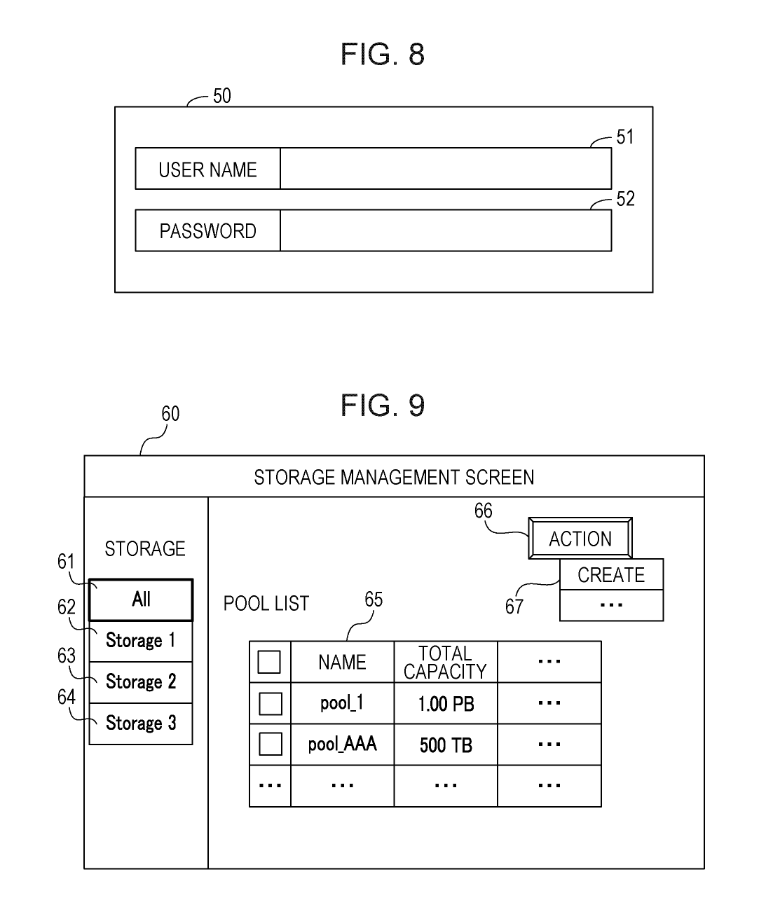

FIG. 8 is a diagram illustrating an example of the login screen. In a login screen 50, input fields 51 and 52 of the user name and the password are provided. When the user correctly inputs a user name and a password in each of the input fields 51 and 52, the storage operation management server 100 performs user authentication and a storage management screen is displayed.

FIG. 9 is a diagram illustrating an example of the storage management screen. In a storage management screen 60, storage selection buttons 61 to 64, a pool list 65, and an action button 66 are set. The storage selection buttons 61 to 64 are buttons for specifying a storage device of which a storage pool is created. The storage selection button 61 is a button which is pressed in a case where a target to be created in the storage pool is not limited. Each of the storage selection buttons 62 to 64 is associated with a storage device of which a storage pool is created when the button is selected.

In the pool list 65, a list of already the created storage pool is displayed. In a case of creating the storage pool, the user presses the action button 66. When the action button is pressed, a pull-down menu is displayed. A creation command 67 is included in the pull-down menu. When the user selects the creation command 67 from the pull-down menu, a storage pool is created by a storage device selected by the storage selection buttons 61 to 64. In a case where the user selects the storage selection button 61, the storage operation management server 100 creates a storage pool by using an appropriate storage device in consideration of a free capacity or the like of each of the storage devices. In a case where the user selects one of the storage selection buttons 62 to 64, the storage operation management server 100 creates a storage pool by using a storage device corresponding to the selected storage selection button.

In a case where the creation command 67 of the storage pool is selected, a pool creation screen is displayed on the terminal device 200.

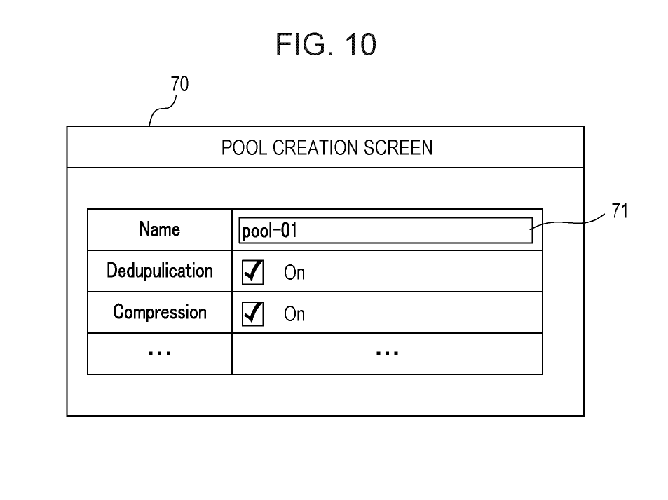

FIG. 10 is a diagram illustrating an example of the pool creation screen. An input field 71 for inputting a pool name is provided on a pool creation screen 70. When the user inputs a name of the storage pool in the input field 71, the input value check is performed on both of the terminal device 200 and the storage operation management server 100.

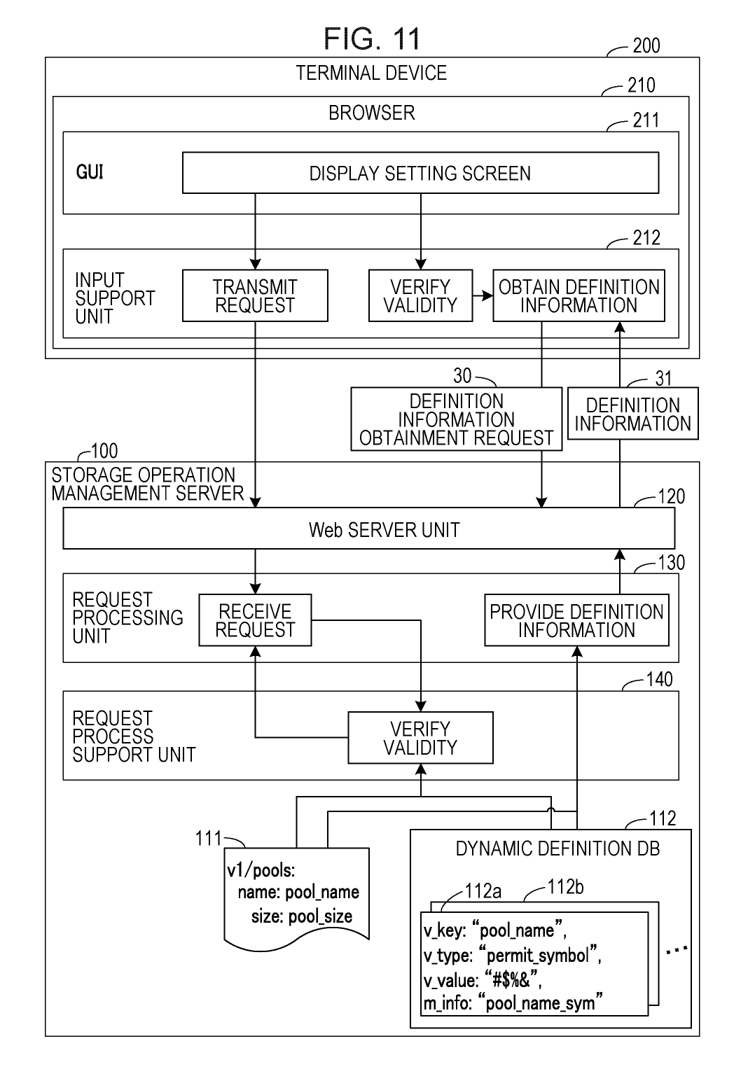

FIG. 11 is a diagram illustrating an example of the input value check process. For example, when the user accesses the storage operation management server 100 by using the terminal device 200, the browser 210 activates the GUI 211 and the input support unit 212. In the GUI 211 activated for storage operation management, for example, a setting screen related to a storage operation (for example, the pool creation screen 70) is displayed.

The input support unit 212 obtains definition information 31 related to a character available to be input to the input field (for example, the input field 71 on the pool creation screen 70) in the setting screen, from the storage operation management server 100. For example, the input support unit 212 transmits a definition information obtainment request 30 to the storage operation management server 100. For example, the API identifier of “v1/pools” and the parameter name of “name” are included in the definition information obtainment request 30. In a case where the user selects the storage device to be operated, an identifier of the selected storage device is included in the definition information obtainment request.

The web server unit 120 receives the definition information obtainment request 30. The web server unit 120 transmits the obtained definition information 31 to the request processing unit 130. The request processing unit 130 transmits a request for obtaining the definition information 31 to the request process support unit 140. The request process support unit 140 generates the definition information 31 related to the input value check of the character string input to the input fields 41 and 42 in the setting screen, based on the static definition file 111 and the dynamic definition DB 112.

The request process support unit 140 transmits the generated definition information 31 to the request processing unit 130. The request processing unit 130 transmits the obtained definition information 31 to the web server unit 120. The web server unit 120 transmits the obtained definition information 31 to the terminal device 200 in response to the definition information obtainment request.

When obtaining the definition information 31, the input support unit 212 of the terminal device 200 stores the obtained definition information 31 in the memory. After then, each time the user inputs one character to the field for an input in the setting screen, the input support unit 212 verifies whether or not the input character is valid to the definition information 31 (validity). In a case where the input character is invalid to the definition information 31, the input support unit 212 notifies that the character is invalid, to the GUI 211. In a case where the input character is invalid, the GUI 211 displays that the input character is invalid on the screen of the browser 210.

When the user confirms the input character string in a state in which all of the input characters are valid to the definition information 31, an operation execution request is transmitted from the GUI 211 to the input support unit 212. The input support unit 212 transmits a process request according to the operation execution request, to the storage operation management server 100.

In the storage operation management server 100, the web server unit 120 receives the operation request. The web server unit 120 transmits the received operation request to the request processing unit 130. The request processing unit 130 transmits the operation request to the request process support unit 140. The request process support unit 140 performs (verifies validity) the input value check on the character string indicated in the operation request, based on the static definition file 111 and the dynamic definition DB 112.

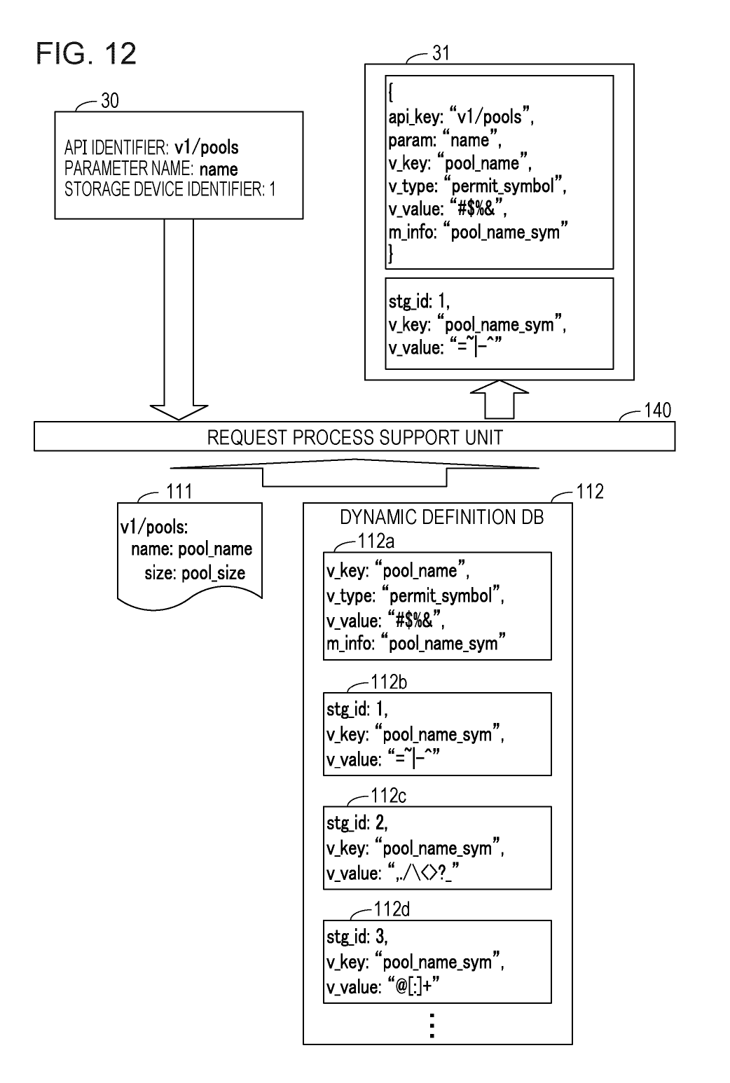

FIG. 12 is a diagram illustrating an example of generating definition information in the storage operation management server. In the example in FIG. 12, the definition information obtainment request 30 includes information of an API identifier of “v1/pools”, a parameter name of “name”, and a storage device identifier of “1”. In this case, the request process support unit 140 obtains a parameter value of “pool_name” corresponding to the parameter name of “name” of the API identifier of “v1/pools” with reference to the static definition file 111. Next, the request process support unit 140 obtains a type of “permit_symbol” and a value of “#$%&” from the record 112a corresponding to the parameter value of “pool_name” among records 112a, 112b, . . . in the dynamic definition DB 112. In the record 112a, “pool_name_sym” is set as a search key (m_info) of the record related to the parameter value of “pool_name” for each of the storage devices. The request process support unit 140 searches for a record including “pool_name_sym” as a key. The request process support unit 140 obtains the type of “permit_symbol” and a value of “=˜|-\hat{ }” from the record 112b of the storage device identifier of “1” indicated in the definition information obtainment request 30, among the searched records 112b to 112d.

Based on the obtained data, the request process support unit 140 generates the definition information 31 to be transmitted to the terminal device 200. For example, in the example in FIG. 12, the definition information 31 indicates that a permitted symbol, for the input value related to an operation not specifying the storage device to be operated, is “#$%&”. In addition, the definition information 31 indicates that a permitted symbol, for the input value related to an operation for the storage device to be operated of the storage identifier of “1”, is “=˜|-\hat{ }”.

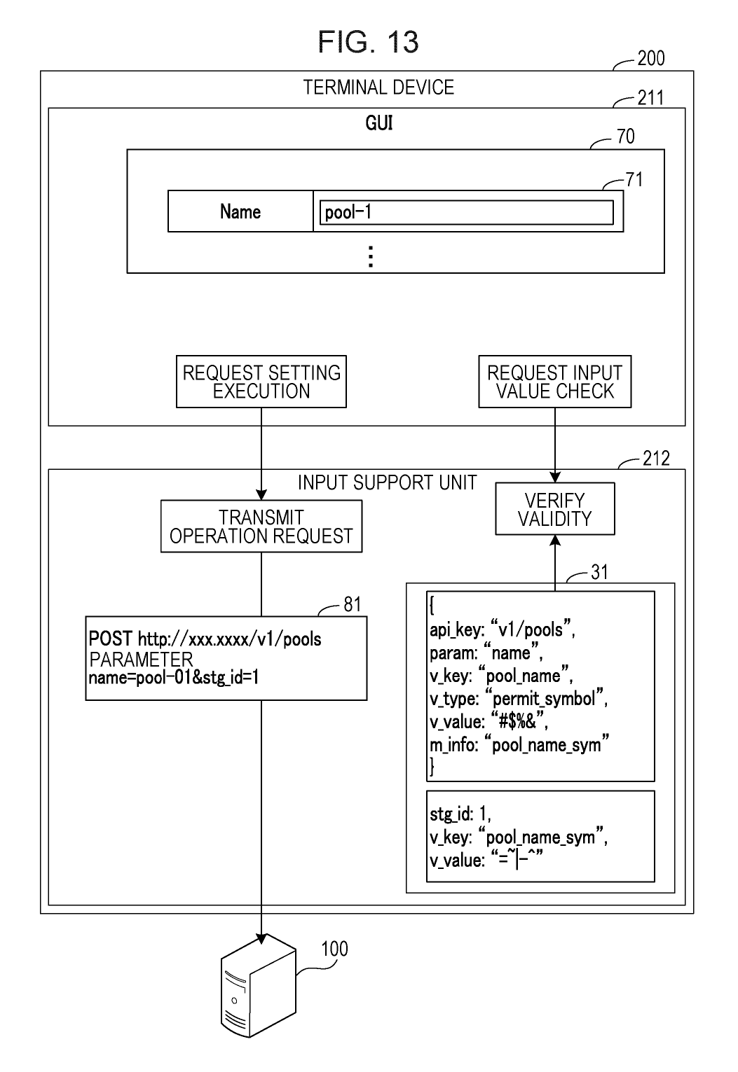

FIG. 13 is a diagram illustrating an example of an input value check in the terminal device. In the example in FIG. 13, “pool-01” is input to the input field 71 for inputting a name of a storage pool using the storage device of the storage identifier of “1”. Each time one character is input to the input field 71, the GUI 211 transmits an input value check request of the input character to the input support unit 212. The input support unit 212 checks the input value with reference to the definition information 31. In the example in FIG. 13, the definition information 31 defines that a half-width character such as an alphabet or a number and symbols of “=˜|-\hat{ }” are available to be input for operating the storage device of the storage identifier of “1”. The input support unit 212 determines that any input character is an appropriate character.

In some cases, as an input item on the pool creation screen 70, a number may be input to a size of the storage pool. In a case where the number is input, the input value check is performed on the numerical value input to the input field, not a number per digit. For example, it is assumed that “1024” (TB) is input to an input field for inputting the size of the storage pool. Each time one character is input to the input field, the GUI 211 transmits an input value check request of the input character to the input support unit 212. The input support unit 212 performs the input value check on the numerical value set to the input filed at this time with reference to the definition information 31. For example, in the definition information 31, it is assumed that a value larger than 1024 TB is indicated as an upper limit of the size of the settable storage pool. In this case, the input support unit 212 determines that the input size is valid.

After then, when the user presses a setting button 44, the GUI 211 transmits a setting execution request to the input support unit 212. The input support unit 212 transmits an operation request 81 to the storage operation management server 100. The operation request 81 includes an API identifier of “v1/pools”, an input character string of “pool-01” of a parameter name of “name”, a storage device identifier of “1”, and the like.

The example in FIG. 13 indicates that a settable character is input, but in some cases, a character not permitted to be set may be input. In this case, an error message is displayed on the terminal device 200.

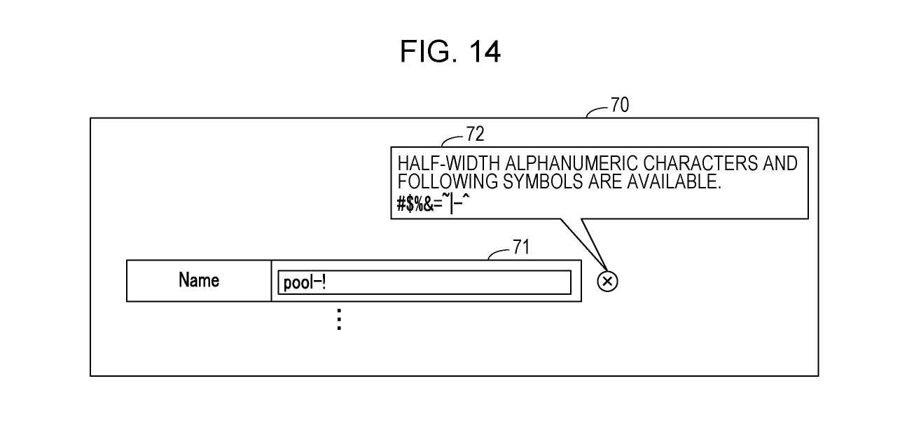

FIG. 14 is a diagram illustrating another example of the input value check in the terminal device. For example, it is assumed that the user inputs a symbol of “!” to the input field 71. This symbol is not included in the symbols of “=˜|-\hat{ }” permitted to be input in a case of operating the storage device of the storage device identifier of “1”. The input support unit 212 determines that the symbol is invalid. The input support unit 212 notifies the GUI 211 of the determination result of invalidation. The determination result of invalidation includes, for example, an error message indicating a reason that the symbol is invalid. The GUI 211 displays the error message on the pool creation screen 70, for example, by a popup menu 72.

The user refers to the error message displayed in the popup menu 72 and recognizes that the input character is inappropriate. After deleting the inappropriate character, the user re-inputs a character permitted as a setting value to the input field 71.

When a correct value is input as illustrated in FIG. 13, the operation request 81 is transmitted to the storage operation management server 100. The storage operation management server 100 checks the input value before operating the storage devices 300, 400, and 500 according to the operation request 81.

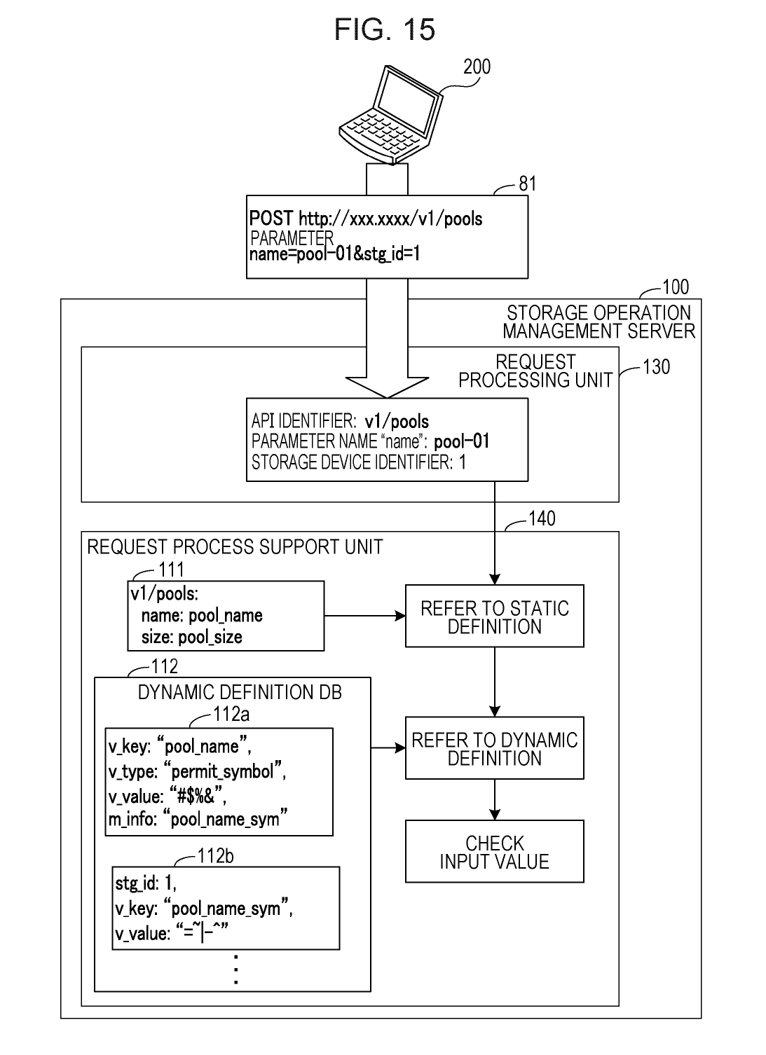

FIG. 15 is a diagram illustrating an example of an input value check in the storage operation management server. After receiving the operation request 81 from the terminal device 200, in the storage operation management server 100, the request processing unit 130 decrypts the operation request 81. The request processing unit 130 extracts, for example, an API identifier, a parameter name, and an input character string from the operation request 81. The request processing unit 130 transmits the extracted information to the request process support unit 140.

The request process support unit 140 firstly refers to the static definition file 111. The request process support unit 140 searches the information in the static definition file 111 by using the parameter name as a search key. In the example in FIG. 15, the request process support unit 140 searches the parameter name of “name” and obtains a definition name of “pool_name” corresponding to the parameter name.

Next, the request process support unit 140 searches the dynamic definition DB 112 by using the definition name of “pool_name” as a search key. Then, the record 112a is searched. The request process support unit 140 obtains the value of “#$%&” of a permitted symbol of “permit_symbol” from the record 112a. When the storage device identifier is not included in the operation request, the request process support unit 140 performs a determination process as to whether or not a symbol other than the obtained value of “#$%&” is included in the character string of “pool-01” input as a parameter value in the operation request 81.

In the example in FIG. 15, the storage device identifier of “1” is included in the operation request. The request process support unit 140 includes “pool_name_sym”, set as a search key (m_info) in the record 112a firstly searched, in a key and obtains the record 112b of the storage device identifier of “1” from the dynamic definition DB 112. The record 112b indicates that available symbols are “=˜|-\hat{ }”. Since the input value of “pool-01” does not include a symbol other than the available symbols of “=˜|-\hat{ }”, the request process support unit 140 determines that the input value is correct.

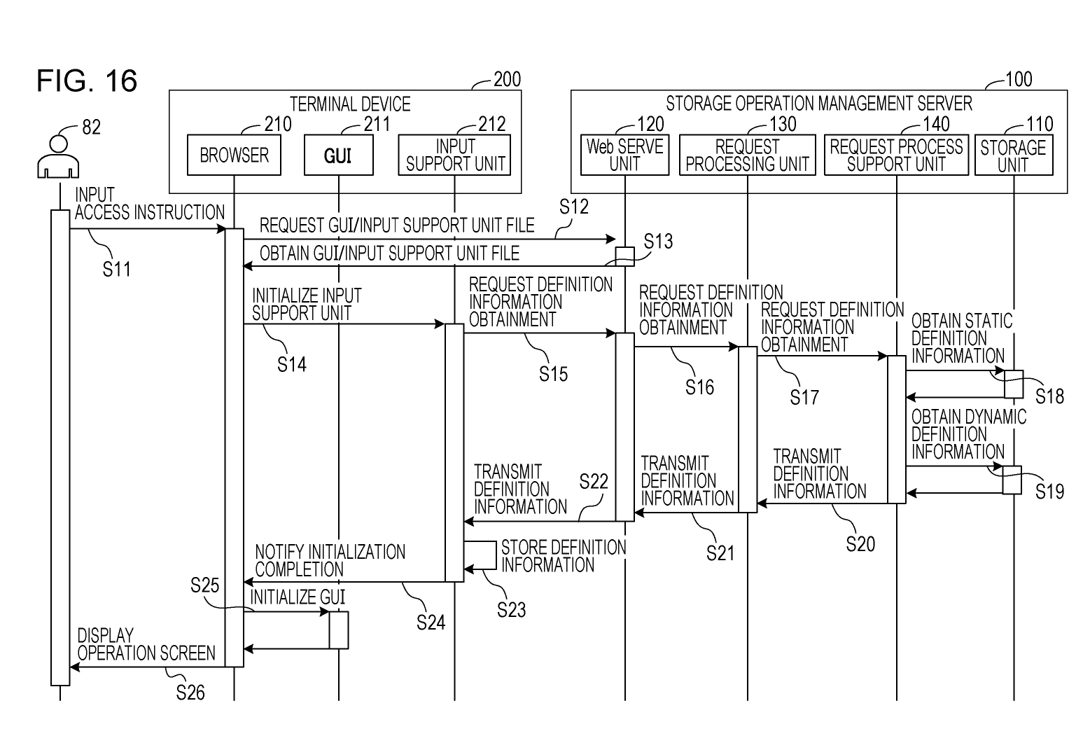

In this manner, in both of the terminal device 200 and the storage operation management server 100, it is possible to perform the input value check by using the common definition information. Hereinafter, with reference to FIGS. 16 to 21, an operation procedure of the storage devices 300, 400, and 500 according to the input value check will be described in detail.

FIG. 16 is a sequence diagram illustrating an example of a procedure of a process of obtaining definition information according to screen display. For example, a user 82 inputs an access instruction to the storage operation management server 100, to the terminal device 200 (step S11). The browser 210 of the terminal device 200 transmits an obtainment request of a file for executing the GUI 211 and the input support unit 212, to the storage operation management server 100 (step S12). In accordance with the file obtainment request, for example, the web server unit 120 of the storage operation management server 100 reads the execution file for the GUI 211 and the input support unit 212 from the internal storage device 103 and transmits the execution file to the terminal device 200 (step S13).

The browser 210 of the terminal device 200 initializes the input support unit 212 (step S14). For example, the browser 210 activates the input support unit 212 by executing the execution file for the input support unit. The input support unit 212 starts the initialization process of the input support unit 212. The input support unit 212 transmits a definition information obtainment request to the storage operation management server 100 in the initialization process (step S15). At this time, since the user 82 does not select the storage device, the definition information obtainment request for common definition information independent of the storage device is performed.

When receiving the definition information obtainment request, the web server unit 120 of the storage operation management server 100 which receives the definition information obtainment request transmits the definition information obtainment request to the request processing unit 130 (step S16). The request processing unit 130 transmits the received definition information obtainment request to the request process support unit 140 (step S17). The request process support unit 140 obtains static definition information from the static definition file 111 in the storage unit 110 (step S18). The request process support unit 140 obtains dynamic definition information from the dynamic definition DB 112 in the storage unit 110 (step S19). The request process support unit 140 generates definition information by integrating the obtained static definition information and dynamic definition information and transmits the generated definition information to the request processing unit 130 (step S20). The request processing unit 130 transmits the received definition information to the web server unit 120 (step S21). The web server unit 120 transmits the received definition information to the terminal device 200 (step S22).

In the terminal device 200, the input support unit 212 receives the definition information. The input support unit 212 stores the received definition information in a storage device such as a memory or the like (step S23). After then, the input support unit 212 notifies the browser of initialization completion (step S24). When the initialization of the input support unit 212 is completed, the browser 210 initializes the GUI 211 (step S25). For example, the browser 210 activates the GUI 211 by executing an execution file for the GUI. The GUI 211 starts the initialization process of the GUI 211. The GUI 211 generates an initial operation screen by the initialization process. When the initialization of the GUI 211 is completed, the browser 210 displays the operation screen generated by the GUI 211, on the monitor (step S26). The user 82 operates the displayed operation screen such as an input of a character or the like.

As illustrated in FIGS. 9 and 10, the user 82 may perform an operation of specifying the storage device to be operated. In this case, when the user 82 selects the storage device to be operated, the terminal device 200 obtains dynamic definition information corresponding to the storage device to be operated, from the storage operation management server 100. A procedure of obtaining the dynamic definition information at this time is the same as the processes of steps S15 to S23 in FIG. 16. Meanwhile, in the process of obtaining the dynamic definition information by the request process support unit 140 (step S19), the dynamic definition information is obtained from a record corresponding to the storage device to be operated.

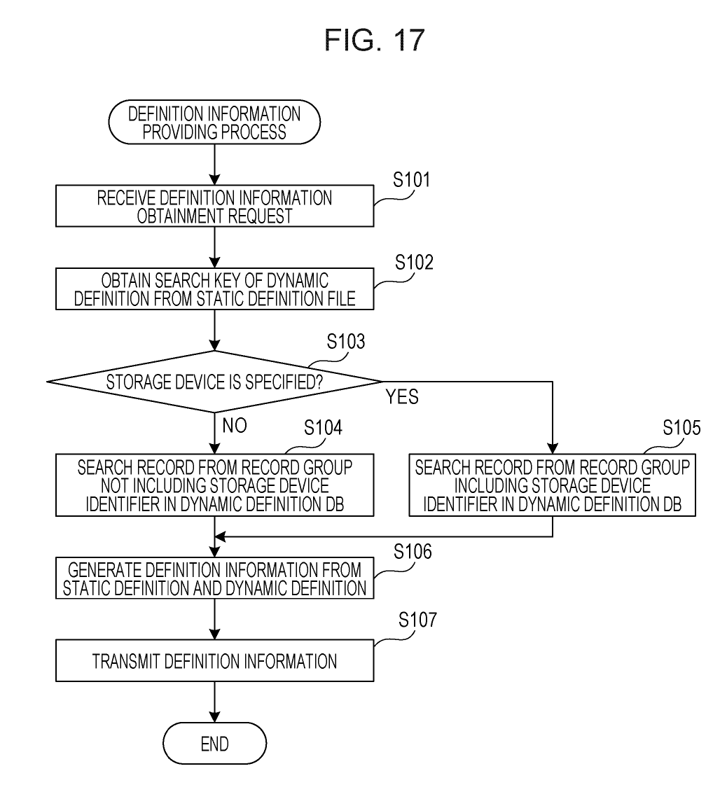

FIG. 17 is a flowchart illustrating an example of a procedure of a process of providing definition information in the storage operation management server. Hereinafter, processes illustrated in FIG. 17 will be described along step numbers.

The storage operation management server 100 receives a definition information obtainment request (step S101). The definition information obtainment request is transmitted to the request process support unit 140 via the web server unit 120 and the request processing unit 130.

The request process support unit 140 obtains a search key of dynamic definition from a static definition corresponding to an API identifier indicated in the definition information acquisition request in the static definition file 111 (step S102).

The request process support unit 140 determines whether or not a storage device to be operated is specified in the definition information obtainment request (step S103). In a case where the storage device is not specified, the request process support unit 140 advances the process to step S104. In a case where the storage device is specified, the request process support unit 140 advances the process to step S105.

The request process support unit 140 searches for a record including the obtained search key (for example, “pool_name”) from a record group not including the storage device identifier in the dynamic definition DB 112 (step S104).

The request process support unit 140 searches for a record from the record group in the dynamic definition DB 112 including an identifier of the storage device specified as the operation target (step S105). For example, the request process support unit 140 firstly searches for a record including the obtained search key (for example, “pool_name”) from a record group not including the storage device identifier in the dynamic definition DB 112. Next, the request process support unit 140 searches for a record including the storage device identifier (for example, “stg_id: 1”) indicating the operation target among records including a search key (for example, “pool_name_sym”) of a definition for each of the storage devices indicated in the record.

The request process support unit 140 generates definition information from the obtained static definition and dynamic definition (step S106).

The request process support unit 140 transmits the generated definition information to the request processing unit 130 (step S107). The request processing unit 130 transmits the received definition information to the web server unit 120. The web server unit 120 transmits the definition information to the terminal device 200.

In this manner, the transmitted definition information is held by the terminal device 200. In the terminal device 200, each time one character is input to the setting screen displayed by the GUI 211, the input value check of the input character is executed.

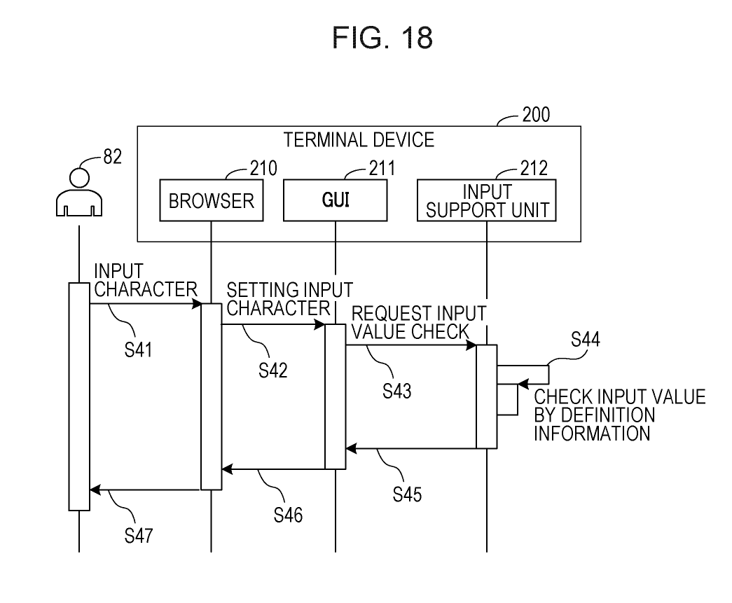

FIG. 18 is a sequence diagram illustrating an example of a procedure of an input value check process in the terminal device. The user 82 inputs a character to the terminal device 200 (step S41). In the terminal device 200, the browser 210 recognizes the input character and sets the character to the GUI 211 (step S42). The GUI 211 requests the input support unit 212 to check the input value of the input character (step S43). Based on the definition information obtained in advance, the input support unit 212 performs the input value check (step S44). The input support unit 212 responds to the GUI 211 with a result of the input value check (step S45). In a case where there is a message (for example, an error message) to be displayed according to the input value check result, the GUI 211 instructs the browser 210 to display the message (step S46). The browser 210 displays the message on the monitor (step S47).

Each time one character is input, the processes illustrated in FIG. 18 are repeated. For example, in a case where a character not matching the definition information is input, the input support unit 212 displays an error message and suggests correction of the character. When a character input of a character valid to the definition information is confirmed, the input support unit 212 transmits an operation request to the storage operation management server 100.

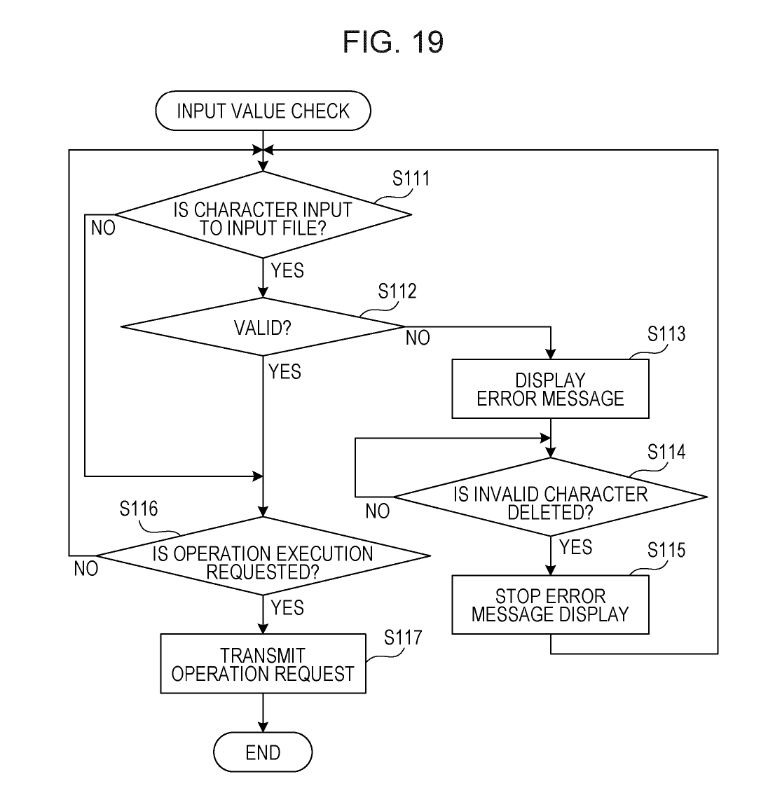

FIG. 19 is a flowchart illustrating an example of a procedure of an input value check process for each character. Hereinafter, processes illustrated in FIG. 19 will be described along step numbers.

The input support unit 212 determines whether or not a character is input to an input field (step S111). In a case where one character is input to the input field, the input support unit 212 advances the process to step S112. In a case where the character is not input to the input field, the input support unit 212 advances the process to step S116.

Based on definition information, the input support unit 212 determines whether or not the input character is valid (step S112). In a case where the input character is valid, the input support unit 212 advances the process to step S116. In a case where the input character is not valid, the input support unit 212 advances the process to step S113.

The input support unit 212 causes the browser 210 to display an error message (step S113). For example, the input support unit 212 transmits the error message that the input character is invalid, to the GUI 211. The GUI 211 instructs the browser 210 to display a popup menu including the received error message. The browser 210 displays the popup menu indicating the error message on the screen.

The input support unit 212 determines whether or not the invalid character is deleted from the input field (step S114). In a case where the character is deleted, the input support unit 212 advances the process to step S115. In a case where the character is not deleted, the input support unit 212 repeats the process in step S114 until the character is deleted.

The input support unit 212 stops displaying the error message (step S115). For example, the input support unit 212 instructs the GUI 211 of a stop instruction of the error message display. The GUI 211 instructs the browser 210 to stop displaying the popup menu of the error message. The browser 210 deletes the popup menu from the screen. After then, the input support unit 212 advances the process to step S111.

The input support unit 212 determines whether or not the user inputs an operation for requesting operation execution (step S116). In a case where the operation execution request is input, the input support unit 212 confirms a character string in an input field and advances the process to step S117. In a case where the operation execution request is not input, the input support unit 212 advances the process to step S111.

The input support unit 212 transmits an operation request according to the character string in the input field, to the storage operation management server 100 (step S117).

In this manner, the operation request including the character string having only an appropriate character according to the definition information is transmitted from the terminal device 200 to the storage operation management server 100. After the input value check is performed in the storage operation management server 100, an operation according to the operation request is executed to the storage device.

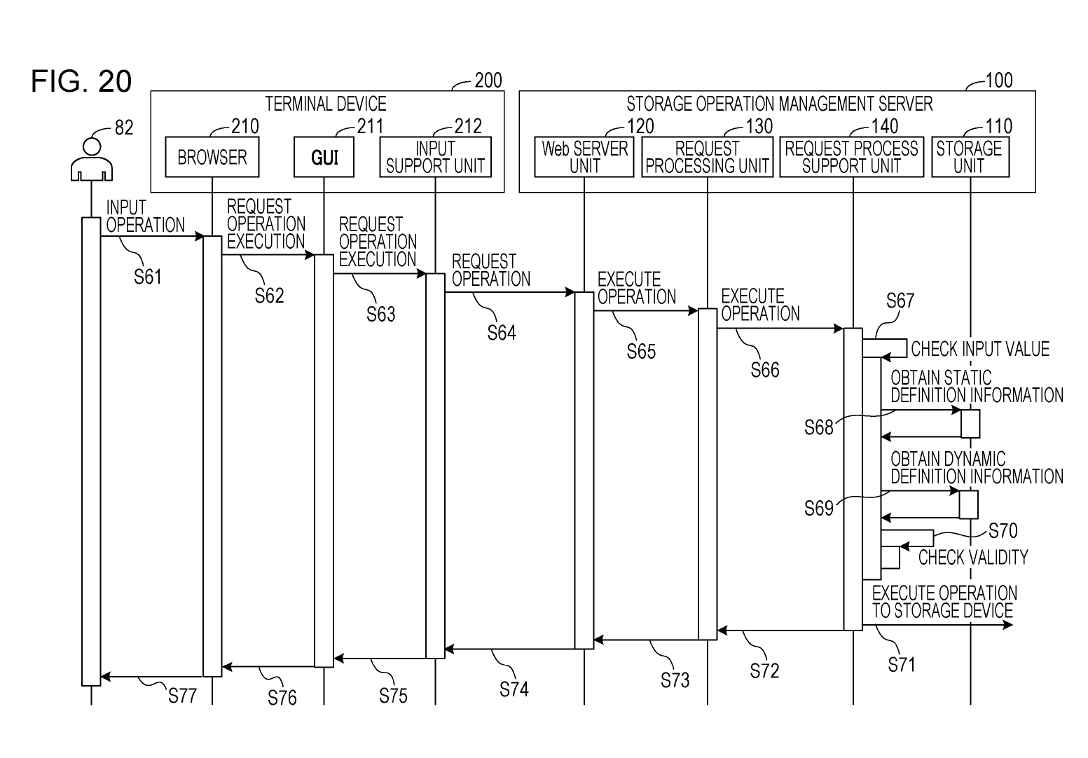

FIG. 20 is a sequence diagram illustrating an example of an operation procedure of the storage device. The user 82 inputs an operation for requesting operation execution (step S61). The browser 210 of the terminal device 200 transmits an operation execution request to the GUI 211 (step S62). The GUI 211 transmits the operation execution request to the input support unit 212 (step S63). The input support unit 212 transmits an operation request to the storage operation management server 100 according to the operation execution request (step S64).

In the storage operation management server 100, the web server unit 120 receives the operation request. The web server unit 120 transmits an operation execution instruction according to the operation request, to the request processing unit 130 (step S65). The request processing unit 130 transmits the operation execution instruction to the request process support unit 140 (step S66).

When receiving the operation execution instruction, the request process support unit 140 starts an input value check process (step S67). The request process support unit 140 firstly obtains static definition information from the static definition file 111 in the input value check process (step S68). Next, the request process support unit 140 obtains dynamic definition information from the dynamic definition DB 112 (step S69). Based on the static definition information and the dynamic definition information, the request process support unit 140 checks validity of the input character (step S70). In a case where the input character is valid, the request process support unit 140 executes an operation according to the operation execution instruction to the storage device to be operated (step S71). For example, the request process support unit 140 instructs the storage management unit 150 to create a storage pool using the storage device. The storage management unit 150 sets the storage pool for the storage device used in the storage pool.

When the operation execution is completed, the request process support unit 140 transmits a completion response of the operation execution to the request processing unit 130 (step S72). The request processing unit 130 transmits the completion response of the operation execution to the web server unit 120 (step S73). The web server unit 120 transmits a result of executing the operation according to the operation request, to the terminal device 200 (step S74). In the terminal device 200, the input support unit 212 receives the execution result. The input support unit 212 transmits the operation execution result to the GUI 211 (step S75). The GUI 211 instructs the browser 210 to display the operation execution result (step S76). The browser 210 displays the operation execution result on the screen (step S77).

In this manner, the storage operation management server 100 also performs the input value check based on the definition information unified with the terminal device 200.

Data in the dynamic definition DB 112 is dynamically updated as the configuration of the storage devices 300, 400, and 500 in the system is changed. The data in the dynamic definition DB 112 is updated by, for example, the request process support unit 140.

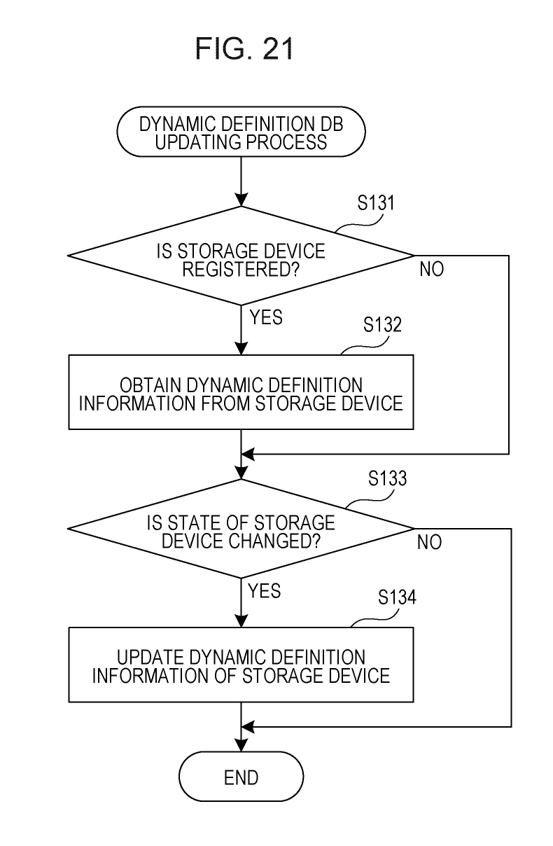

FIG. 21 is a flowchart illustrating an example of a procedure of a process of updating the dynamic definition DB. Hereinafter, processes illustrated in FIG. 21 will be described along step numbers. The dynamic definition DB update process is regularly executed by the request process support unit 140.

The request process support unit 140 determines whether or not a storage device is newly registered in a system (step S131). For example, the storage management unit 150 manages configuration information indicating a storage device configuration in the system. The storage management unit 150 regularly checks the configuration of the system. When a new storage device is connected to the system, the storage management unit 150 obtains information from the connected storage device and updates the managed configuration information based on the obtained information. In a case where the storage management unit 150 detects the new storage device and registers the information of the storage device to the configuration information, the request process support unit 140 determines that the storage device is registered.

In a case where the storage device is registered, the request process support unit 140 advances the process to step S132. In a case where the storage device is not registered, the request process support unit 140 advances the process to step S133.

The request process support unit 140 obtains dynamic definition information from the storage device newly registered (step S132). For example, the request process support unit 140 instructs the storage management unit 150 to obtain the dynamic definition information from the storage device newly registered. According to the instruction, the storage management unit 150 obtains the dynamic definition information from the storage device and transmits the obtained dynamic definition information to the request process support unit 140. The request process support unit 140 additionally registers a record indicating the obtained dynamic definition information, in the dynamic definition DB 112.

The request process support unit 140 determines whether or not a state of the storage device is changed (step S133). For example, the storage management unit 150 regularly checks the state of the registered storage device (including the dynamic definition information). When there is a change in the state of the storage device, the storage management unit 150 detects the change and notifies the request process support unit 140 of the change. In a case of receiving the notification that the state of the storage device is changed, the request process support unit 140 determines that the state of the storage device is changed, in step S133.

In a case where the state of any of the storage device is changed, the request process support unit 140 advances the process to step S134. In a case where the state of any of the storage device is not changed, the request process support unit 140 completes the dynamic definition update process.

The request process support unit 140 obtains dynamic definition information of the storage device having the changed state, from the storage device via the storage management unit 150 (step S134). The request process support unit 140 updates the record indicating the dynamic definition information of the storage device in the dynamic definition DB 112 based on the obtained dynamic definition information.

By appropriately updating the dynamic definition DB information, the data in the dynamic definition DB 112 may be maintained up to date.

As described above, according to the second embodiment, it is possible for the terminal device 200 and the storage operation management server 100 to perform the input value check based on the unified definition information. As a result, it is possible to suppress that mismatching (specification discrepancy) occurs between the contents of the input value check in the terminal device 200 and the contents of the input value check in the storage operation management server 100. As a result, quality of a service of the system is improved.

Meanwhile, the terminal device 200 obtains a file for realizing the GUI 211 or the input support unit 212 from the storage operation management server 100, and a component of the file may not be individually developed on a side of the terminal device 200. For this reason, it is possible to suppress that undesirable work due to duplicated development (double development) of the software component for the input value check process in both of the terminal device 200 and the storage operation management server 100 occurs.

### Other Embodiment

In the second embodiment, the example of checking the input value of the character input at the time of creating the account or the storage pool is described, but in the same manner, it is possible to check the input value by the unified definition information even for a character input for another purpose.

The storage unit 110, the web server unit 120, the request processing unit 130, and the request process support unit 140 of the storage operation management server 100 may be provided in each of the storage devices 300, 400, and 500. In this case, the terminal device 200 may directly perform the operation related to the storage device such as storage pool creation, on the storage devices 300, 400, and 500 without going through the storage operation management server 100. Even in a case where the storage devices 300, 400, and 500 are directly operated by the terminal device 200, the unified input value check is performed between the terminal device 200 and the storage device to be operated.

In the second embodiment, as an example of the input value check, the example of determining validity according to a type of a character permitted to be input, but it is also possible to perform another input value check. For example, terminal device 200 and the storage operation management server 100 may check whether or not an input numerical value is within a range of a permitted numerical value set in advance in both of the storage operation management server 100 and the terminal device 200.

Hereinbefore, the embodiments are exemplified, the configuration of each unit described in the embodiment may be replaced with another unit having the same function. In addition, any other component or step may be added. Further, any two or more configurations (features) of the embodiments described above may be combined.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing system comprising a server and a terminal device, wherein
the server including:
a first memory; and
a first processor coupled to the first memory and configured to:
store definition information defining a permissible range of an input value in the memory;
output the definition information according to an obtainment request; and
execute a process using the input value included in a process request according to the process request including the input value; and
the terminal device including:
a second memory;
a display device; and
a second processor coupled to the second memory and configured to:
transmit the obtainment request to the server;
receive the definition information from the server;
display a screen including an input area of the input value on the display device;
determine whether or not the input value is within the permissible range based on the definition information received from the server, when the input value is input to the input area; and
transmit the process request including the input value to the server in a case where it is determined that the input value is within the permissible range.

2. The information processing system according to claim 1,
wherein when receiving the process request, the first processor of the server determines whether or not the input value included in the process request is within the permissible range based on the definition information, and in a case where it is determined that the input value is within the permissible range, the first processor executes the process by using the input value.

3. The information processing system according to claim 1,
wherein each time one character is input to the input area, the second processor of the terminal device determines whether or not the input one character is within the permissible range.

4. The information processing system according to claim 1,
wherein the first memory of the server stores definition information for each of a plurality of storage devices, and the first processor of the server responsively outputs the definition information for a storage device to be operated according to the obtainment request that specifies the storage device to be operated, and
the second processor of the terminal device transmits the obtainment request that specifies the storage device to be operated to the server according to a selection input of the storage device to be operated and receives the definition information for the storage device to be operated, from the server.

5. The information processing system according to claim 4,
wherein the first processor of the server monitors states of the plurality of storage devices, and in a case where one storage device of which a state is changed is detected, the first processor obtains the definition information for the one storage device for defining the permissible range of the input value with respect to the one storage device, from the one storage device, and stores the obtained definition information for the one storage device in the first memory in association with the one storage device.

6. A non-transitory computer-readable storage medium having stored an input value verification support program causing a computer to execute a process comprising:
storing definition information defining a permissible range of an input value in a memory;
outputting the definition information according to an obtainment request; and
executing a process using the input value included in a process request according to the process request including the input value.

7. A non-transitory computer-readable storage medium having stored an input value verification program causing a computer to execute a process comprising:
receiving a definition information defining a permissible range of an input value from a server;
displaying a screen including an input area of the input value on a display device;
determining whether or not the input value is within the permissible range based on the definition information received from the server, when the input value is input to the input area; and
transmitting a process request including the input value to the server in a case where it is determined that the input value is within the permissible range.
